(19) United States
(12) Patent Application Publication
(10) Pub. No.: US 2006/0153006 A1
(43) Pub. Date: Jul. 13, 2006

(54) Architecture of an acoustic multistatic system

(75) Inventor: Jean-Pierre Baudoux, Antibes (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: Thales, Neuilly Sur Seine (FR)

(21) Appl. No.: 10/559,683

(22) PCT Filed: Jun. 3, 2004
(86) PCT No.: PCT/EP04/51007

§ 371 Date: Dec. 6, 2005

(30) Foreign Application Priority Data
Jun. 6, 2003 (FR) 0306883

(51) Int. Cl. G01S 15/87

(52) U.S. Cl. 367/124

(57) ABSTRACT

The present invention relates to a multistatic sonar system having a particular mode of communication between the emitter base and the receiver bases responsible for detecting the sonar echoes. This system makes it possible in particular to circumvent the drawbacks occasioned by the use of radio communications or of satellite-based communications generally used. The signal emitted by the emitter base comprises an apprisal pulse conveying information pertaining to the mode of operation of the system according to the invention, in particular the instant of emission, and a sonar pulse proper. This system is especially intended for use by underwater vessels while diving, for detecting and locating surrounding objects or controlling the positioning of an autonomous underwater vehicle.

### BACKGROUND OF THE INVENTION

The present invention relates to a multistatic sonar system in which the communication between the emitter base and the receiver bases, responsible for detecting the sonar echoes, is done acoustically. This system makes it possible in particular to circumvent the drawbacks occasioned by the use of radio communications or of satellite-based communications, generally used to synchronize the emission and reception functions. This system is intended in particular for use by underwater vessels while diving.

An important characteristic of multistatic sonar systems consists in the physical separation that exists between the emitter base from which the sonar pulse originates and the receiver bases responsible for detecting and locating sonar echoes. Such systems have the advantage in particular of possessing a flexible and modular architecture, the complexity of which may be tailored to the geographical and operational situation. The multistatic sonar thus formed can comprise, as the case may be, a variable number of receiver bases. On the other hand such an architecture requires the existence of means of communication between the emitter base which synthesizes and emits the sonar pulse and the receiver bases which receive the echoes. Specifically, in so far as one wishes to achieve coherent detection, the receiver bases must be informed of the operating parameters of the system. These parameters provide details regarding for example the type of pulse emitted, the frequency of emission, the period of repetition or else regarding the instant of emission. Other information such as the position of the emitter base and that of the receiver bases, which makes it possible to reference the measurements of the instants of arrival of the echoes, also passes via these means of communication.

To establish a communication between the emitter base and the receiver bases, it is well-known current practice to use a radio link, for example an RF or satellite based link.

The information transmitted is generally of two types:

context information relating to the nature of the pulse emitted (coding, duration, etc.), the position of the emitter base, the general configuration of the sonar system or else date information,

synchronization information making it possible to accurately ascertain the instant of emission of the sonar pulse and to calculate the distance separating the objects having returned echoes from the receiver bases.

Subsequently in the document this information will be referred to as mode information.

The use of a radio link has the advantage of allowing the simultaneous transmission of a large amount of information, the bandwidth of the signal emitted possibly being considerable. On the other hand, in a certain number of circumstances, a radio link turns out to be difficult or even impossible to use. Such is the case in particular in respect of underwater craft when they are diving. Such is also the case for example when the operational context excludes the use of radio emissions, for reasons of stealth.

### SUMMARY OF THE INVENTION

The subject of the invention alleviates these drawbacks by proposing a multistatic sonar system in which the transmission of the operating information between the emitter base and the receiver bases is performed by means of an acoustic signal.

The system according to the invention has, among other advantages, that of operating regardless of the depth of submersion of the emitter base and receiver bases and may therefore be implemented by submarines while diving. The present invention also has the advantage of allowing the real-time transmission of operating information. This information is transmitted in tempo with the sonar pulses. The acoustic signal carrying the operating information and the sonar pulse, are advantageously transmitted by a single emitter device, the two signals being separated by a time interval Δt which may be variable and whose value may be contained in the operating information. The latter information may moreover be encrypted.

### BRIEF DESCRIPTION OF THE DRAWINGS

Other characteristics and advantages will become apparent in the wake of the description illustrated by FIGS. 1 to 3 which represent:

FIG. 1, an illustration of a multistatic sonar system according to the prior art,

FIG. 2, an illustration of a system according to the invention,

FIG. 3, an illustration of the structure of the acoustic signal emitted by the system according to the invention.

### DETAILED DESCRIPTION

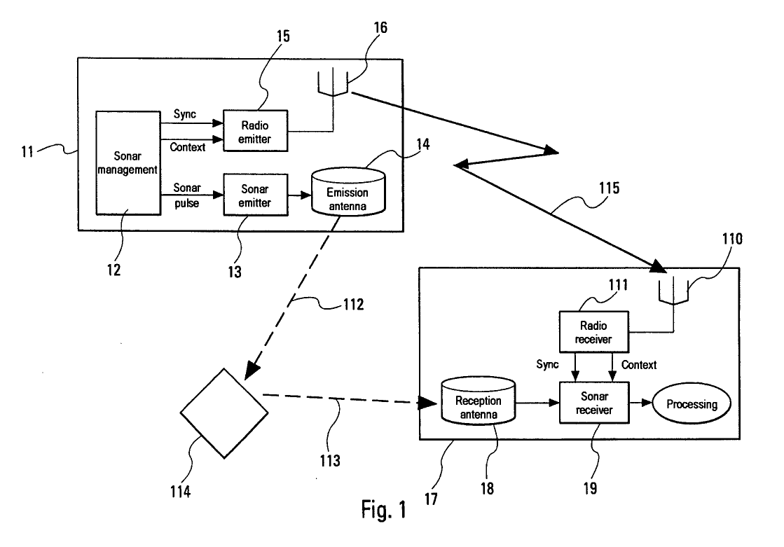

The illustrations of FIGS. 1 to 3 are presented by way of example so as to facilitate the description of the invention. They do not of course represent a limitation as to the structure or to the embodiment of the system according to the invention.

FIG. 1 illustrates a typical multistatic sonar system structure known from the prior art.

This structure comprises an emitter base and one or more receiver bases. For reasons of clarity FIG. 1 depicts just one receiver base.

The emitter base 11 chiefly comprises two subassemblies, a subassembly intended for emitting the sonar pulse and a subassembly intended for transmitting the operating information. These two subassemblies are moreover managed by the sonar management facility 12.

The subassembly intended for emitting the sonar pulse comprises in a conventional manner a sonar emitter 13 and an acoustic antenna 14.

The subassembly intended for transmitting the mode information comprises a radio emitter 15 and an antenna 16.

In symmetric fashion, each receiver base 17 comprises a subassembly for receiving the sonar echoes 113 reflected by the objects 114 lying in the zone covered by the sonar emission 112. This subassembly itself comprises an acoustic antenna 18 and a passive sonar receiver 19.

The receiver base 17 also comprises a subassembly for receiving the operating information itself comprising an antenna 110 and a radio receiver 111.

The illustration of FIG. 1 makes it possible to appreciate the limitations of such a structure. In particular, the use of an electrical radio link 115 for the communications between the emitter base and the receiver bases necessarily implies that at least the elements 16 and 20 remain on the surface. The system is therefore hardly compatible with bases 11 and 17 carried by underwater craft deploying at depth. Moreover, it may be noted that even under operational conditions, in so far as the emitter base must be capable of communicating with several receiver bases, it is difficult to use a highly directional radio emission. The communication of the emitter base with the receiver bases therefore brings about an emission that is sensitive to meteorological conditions, that is not very stealthy and can be detected by hostile elements. This results in significant risks of jamming or of disturbance. This absence of stealth which reveals the presence of the system may render this system ineffective.

Additionally a structure such as illustrated by FIG. 1 turns out to be complex in its structure, the transmission of the operating information requiring a transmission chain 15, 16 specific to this function and independent of the emission of the sonar pulse.

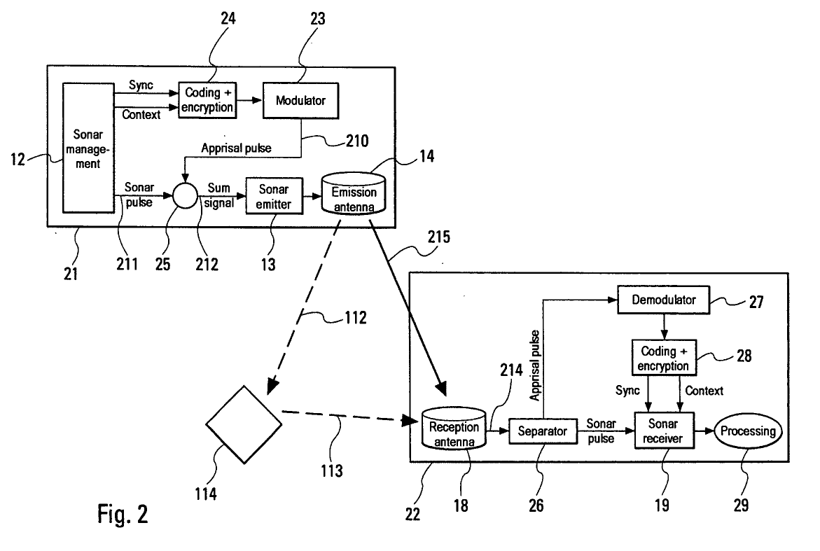

FIG. 2 diagrammatically presents the base structure of the system according to the invention. Like that described in FIG. 1, this system comprises an emitter base 21 and generally several receiver bases 22. On the other hand, in contradistinction to the system illustrated by FIG. 1, the base 21 communicates with the bases 22 via an acoustic link. The mode information and the sonar pulse are thus transmitted via the same channel.

For this purpose the emitter base 21 comprises a modulator 23, making it possible to generate a modulated acoustic pulse 210. This pulse is modulated by the mode information coded by means of the coding device 24. The coding of the information may for example consist in the production of a binary message comprising the number of bits required for the representation of the information. The modulator 23 makes it possible to modulate the acoustic pulse by means of the signal consisting of the binary message. The modulation produced may for example consist of a modulation by frequency hopping or phase hopping. The modulated acoustic pulse, carrying the mode information, is also referred to as the apprisal pulse.

The emitter base 21 also comprises a summator device 225 which makes it possible to calculate the sum of the apprisal pulse and of the sonar pulse 211 provided by the management device 12. It finally comprises a sonar emitter 13 and an acoustic antenna 14 which emit the sum signal 212 into the propagation medium.

In an analogous manner, the structure of each receiver base is tailored to the reception of mode information and of the sonar echoes on one and the same reception channel. For this purpose the base comprises a single acoustic antenna 18 which transforms the signals received into electrical signals 24. The signals received correspond on the one hand to the information messages which come from the emitter base by direct transmission 215 and on the other hand to the echoes 217 reflected by the objects 218 that may lie in the zone covered by the sonar emission 216. The receiver base also comprises a separator device 26 making it possible to separate the sonar echoes from the apprisal pulses. It also comprises a demodulator 27 and a decoding device 28 making it possible to recover the mode information required to configure the receiver 19 in such a way as to optimize the reception of the sonar echoes. It finally comprises processing means 29 which process the sonar echoes received in such a way as to determine the position of the objects 114.

According to a variant structure, in the case of an acoustic antenna comprising several hydrophones, it is possible to assign more specifically certain hydrophones to the reception of the apprisal pulse. The antenna of the receiver base is then split into two subassemblies. This structure may culminate in the complete separation of the pathways for receiving the apprisal pulses and for receiving the sonar echoes, the receiver base then no longer comprises any separator device 26.

As may be noted in FIG. 2, the structure of the system according to the invention has the advantage of not comprising any electrical radio link and hence of being able to operate in total submersion. It also makes it possible to pass the mode information and the sonar pulse through one and the same channel and to thus ensure temporal concordance between the two signals.

The structure of the system according to the invention may advantageously be supplemented with encryption/decryption means associated with the means of coding 24 and of decoding 28 of the mode information. These means have the effect of preventing direct reading of the mode information by third parties.

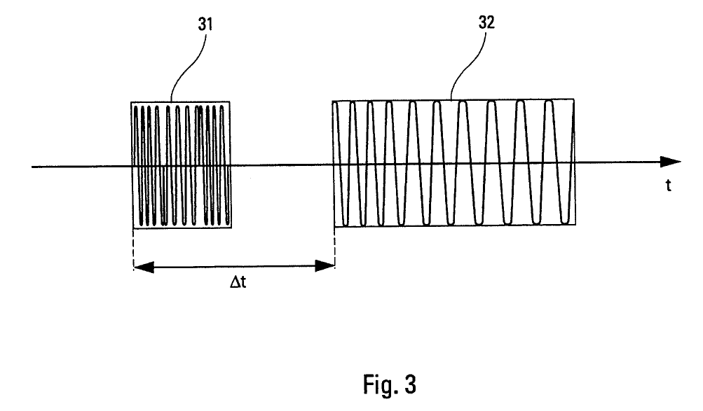

FIG. 3 diagrammatically presents in a general manner the structure of the signal utilized by the system according to the invention. The signal presented in FIG. 3 is emitted by the emitter base 21 destined for the receiver bases. It comprises in particular the apprisal pulse 31 which contains the mode information which follows the direct path 215 of FIG. 2.

The signal emitted also comprises the sonar pulse 32 proper. In FIG. 3 the two pulses which make up the emission signal are spaced apart by a time interval Δt. This time interval allows in particular the various receiver bases making up the system to receive and to decode the apprisal pulse before receiving an echo of the sonar pulse. The mode information carried by the apprisal pulse is utilized by the receiver bases to configure their receiver in accordance with the shape of the pulse emitted.

The duration Δt may be variable as a function of the applications. It may for example have been predetermined for each mode of operation and be known to the receiver bases. It may indeed be fixed during the operation of the system and be transmitted to the receiver bases as mode information. The constraint on the value of Δt is in particular imposed by the time required by the receiver bases to configure themselves before receiving the echoes from the sonar pulse and to take into account the durations of the required acoustic paths.

In a particular embodiment, a zero interval Δt may even be envisaged. The two pulses are then immediately consecutive.

As illustrated in FIG. 3, the signal emitted by the emitter base is, in the case of the system according to the invention, a composite signal formed of two pulses of different structures.

The sonar pulse is a pulse of conventional shape, known elsewhere. It may for example be of fixed frequency or else assigned a particular modulation law.

The apprisal pulse for its part forms the subject of a particular modulation. The modulating signal represents the whole set of mode information to be transmitted. It consists for example of the concatenation of the data pertaining to the mode information, put into binary form. These concatenated data form a word or a frame comprising a given number of bits dependent on the nature of the information transmitted.

This signal will modulate the apprisal pulse through a digital modulation device, of modem type for example. As stated previously, the modulation code may for example be a coding by phase or frequency hopping, phase and frequency hopping or any other digital coding.

The duration of the apprisal pulse is dependent on the amount of mode information to be transmitted to the receiver bases. In practice the duration of the apprisal pulse is of the order of a few seconds. This duration which corresponds to the time required to transmit a few hundred to a few thousand bits of information, is compatible with the conventional bandwidths of the sonar emitters. The system according to the invention therefore advantageously does not require the use of particular means of emission. Thus, for example, an emitter having a bandwidth equal to 1 kHz will be able to transit an apprisal pulse of 1 s conveying a mode message of a length equal to around 1 kbits.

The manner of operation of the system according to the invention may be described with the aid of FIGS. 2 and 3. The signal emitted by the emitter base is a signal comprising two pulses: an apprisal pulse 31 and a sonar pulse 32. The emitter base may for example be the active sonar of a submarine. The apprisal pulse is received in direct fashion by the receiver bases. Each of the receiver bases is moreover equipped in a known manner, with means allowing it to ascertain its position with respect to the emitter base. Each base carries out the decoding of the mode information. This information comprises in particular the value Δt of the time which separates the instant of emission of the apprisal pulse, from that of emission of the sonar pulse. Knowledge of Δt allows the receiver bases to ascertain the instant of emission of the sonar pulse and to perform a measurement of the delay between the pulse emitted and the instant of arrival of an echo. The assembly of receiver bases thus behaves like a multistatic active sonar.

In the illustration of FIG. 2, the emitter base is portrayed as comprising a single sonar emitter, the apprisal pulse and the sonar pulse being emitted by one and the same emitter 13. This solution represents an economical embodiment in terms of bulkiness and cost. Nevertheless this solution is not limiting and it is of course possible to use two different acoustic emitters if the need to have two separate emitters is apparent.

According to an embodiment of the system, the instant of emission of the sonar pulse is deduced from the instant of reception of the apprisal pulse. The receiver bases perform for example a detection of the envelope of the apprisal pulse and allocate the sonar pulse an instant of emission dependent on the instant of reception of the apprisal pulse and Δt.

According to another embodiment, the receiver bases and the emitter base are previously synchronized. The mode data thus integrate information providing the precise date of emission of the sonar pulse, thereby allowing the receiver bases to ascertain the instant of emission of the sonar pulse.

The structure of the signal emitted has the advantage of rendering the system parametrizable and hence easily tailored. In particular, by virtue of the information that can be transmitted through the apprisal pulse, it makes it possible to modify the configuration of the system in real time. As a function of the information transmitted, it is for example possible to alter the frequency of emission of the sonar pulse, its type of modulation or else the value of the gap Δt which separates the apprisal pulse from the sonar pulse: protection against such a sonar is thus rendered difficult. It is moreover possible as illustrated by FIG. 2, to perform the encrypting of the mode information before modulation. In this way, in the absence of the decryption key, it is impossible to gain access to the mode parameters of the system.

In the above description the mode of emission described comprises a signal emitted systematically composed of two pulses. Such a signal is required in particular in the case where one wishes to be able to modify certain mode information from one emission to the next. It is nevertheless possible to envisage simpler modes of operation, for which the operating parameters remain unchanged over a relatively long time. In this case it is for example possible to design a system for which the emission signal is sometimes composed of an apprisal pulse followed by an emission pulse, and sometimes simply of an emission pulse. It is also possible to design a system for which the emission signal is composed of an apprisal pulse followed by several emission pulses. The pattern emitted by the system according to the invention can take various forms as a function of the applications.

As was stated previously the system according to the invention applies in particular to the embodying of a multistatic sonar intended for locating echoes coming from objects situated in a zone under surveillance. However, this application is not the only one that may be envisaged and in no way limits the field of use of the system. It is for example also possible to use it to carry out the positioning of autonomous underwater vehicles. In this type of application, the emitter base is situated on the autonomous craft and the receiver bases are for example positioned on surface vessels.

1-12. (canceled)

13. A multistatic acoustic system, comprising:
an emitter base comprising means of emission of sonar pulses;
a receiver base comprising means of reception and of processing of sonar echoes;
the emitter base also comprising means for transmitting mode information to the receiver base wherein the mode information is transmitted to the receiver base in acoustic form by an appraisal pulse, said appraisal pulse being modulated by a signal containing said mode information.

14. The system as claimed in claim 13, wherein an appraisal pulse and a sonar pulse are emitted by a single emitter successively emitting the two pulses.

15. The system as claimed in claim 13, wherein a sonar pulse and an appraisal pulse are separated by a time interval Δt dependent on the mode of operation of the system and known to the receiver bases.

16. The system as claimed in claim 13, wherein, Δt being equal to zero, two pulses are emitted so as to be immediately consecutive.

17. The system as claimed in claim 14, wherein, Δt being equal to zero, the two pulses are emitted so as to be immediately consecutive.

18. The system as claimed in claim 13, wherein a sonar pulse and an appraisal pulse are separated by a time interval Δt dependent on the mode of operation of the system and known to the receiver bases.

18. The system as claimed in claim 14, wherein a sonar pulse and an appraisal pulse are separated by a time interval Δt dependent on the mode of operation of the system and known to the receiver bases.

19. The system as claimed in claim 13, wherein a sonar pulse and an appraisal pulse are separated by a time interval Δt whose duration is transmitted to the receiver bases with the mode information.

20. The system as claimed in claim 14, wherein a sonar pulse and an appraisal pulse are separated by a time interval Δt whose duration is transmitted to the receiver bases with the mode information.

21. The system as claimed in claim 13, wherein the modulation of the appraisal pulse by the modulating signal containing the mode information is carried out by digital coding.

22. The system as claimed in claim 14, wherein the modulation of the appraisal pulse by the modulating signal containing the mode information is carried out by digital coding.

23. The system as claimed in claim 21, wherein the modulation of the appraisal pulse by the modulating signal containing the mode information is carried out by phase-hopping coding.

24. The system as claimed in claim 22, wherein the modulation of the appraisal pulse by the modulating signal containing the mode information is carried out by phase-hopping coding.

25. The system as claimed in claim 21, wherein the modulation of the appraisal pulse by the modulating signal containing the mode information is carried out by frequency-hopping coding.

26. The system as claimed in claim 22, wherein the modulation of the appraisal pulse by the modulating signal containing the mode information is carried out by frequency-hopping coding.

27. The system as claimed in claim 13, wherein the instant of emission of the sonar pulse is determined on the basis of the instant of reception of the appraisal pulse by the receiver bases and of the mode of operation.

28. The system as claimed in claim 14, wherein the instant of emission of the sonar pulse is determined on the basis of the instant of reception of the appraisal pulse by the receiver bases and of the mode of operation.

29. The system as claimed in claim 13, wherein the instant of emission of the sonar pulse is determined on the basis of the date of emission of said sonar pulse, contained in the mode message.

30. The system as claimed in claim 14, wherein the instant of emission of the sonar pulse is determined on the basis of the date of emission of said sonar pulse, contained in the mode message.

31. The system as claimed in claim 13, further comprising means for encrypting the mode information.

32. A process for controlling the position of an autonomous underwater craft, said process using the system as claimed in claim 17.

33. A process for controlling the position of an autonomous underwater craft, said process using the system as claimed in claim 18.
